(19) United States
(12) Patent Application Publication
(10) Pub. No.: US 2013/0013680 A1
(43) Pub. Date: Jan. 10, 2013

(54) SYSTEM AND METHOD FOR DETERMINING INTERPERSONAL RELATIONSHIP INFLUENCE INFORMATION USING TEXTUAL CONTENT FROM INTERPERSONAL INTERACTIONS

(75) Inventors: Ajay K. Gupta, Vasant Kunj (IN); Rohit M Lotlikar, Koramangala (IN); Angshu Rai, Maharashtra (IN)

(73) Assignee: International Business Machines Corporation, Armonk, NY (US)

(21) Appl. No.: 13/177,998

(22) Filed: Jul. 7, 2011

(51) Int. Cl. G06F 15/16

(52) U.S. Cl. 709/204

(57) ABSTRACT

A non-transitory computer storage medium stores a method that determines interpersonal relationship influence information between participants in an interaction channel that includes inputting an interaction text response of communication by a participant made in an interaction channel. A type of influence relation of the interaction text response is determined on at least one other participant in the interaction channel based on relational descriptors. An influence score value for the interaction text response is determined, where the influence score value indicates how strongly the interaction text response influences the at least one other participant in the interaction channel. A pair-wise indication of a direction of influence of at least two participants in the interaction channel is determined. Interpersonal relationship influence information is output for the interaction text response for a participant pair in the interaction channel.

### BACKGROUND

The embodiments herein relate to a framework that uses textual content to derive interpersonal influence including a nature, an extent and a direction of influence from interpersonal interactions of participants within a communication channel.

Currently, influence relations between participants in a communication channel are derived from incomplete indicators like, “who-knows-whom,” and the value of a number of interactions. In the telecom domain, CDRs (Call Detail Records) are used to define relations based on duration of call, service medium used, etc. In the web domain, Friend/Follower lists and number of interactions is used to define relations.

The present invention provides a technique to derive interpersonal influence relationships reliably using analysis of textual interactions between people to determine the nature, extent and direction of influence among them.

Understanding influence relationships among interacting individuals provide organizations with critical information in assessing broader impact of organizational decisions. The individuals could be internal or external to the organization. For example, External Interactions are how customer's influence each other (mainly for business to consumer (B2C) organizations), as well as how members of the organization influence customers. Additionally, Internal Interactions are how members of the organization influence each other (any type of organization—a business, a community volunteer organization, non-profits, and government departments).

With external channels for influence, consumers tend to publish their experience with business on public forums such as customer/user forums, Twitter, Facebook, blogs, etc.

With internal channels for influence, members of an organization use internal forums such as online discussion forums, open conference calls, all-hands meetings, etc.

Exchanges on these forums are relevant indicators of a person's views/opinions, satisfaction with the organization and loyalty. Additionally, each person who says something ends up influencing other people in the forum. Identifying the structure influence relationships is critical to applications of viral marketing, customer retention prediction and human resource decisions such as role changes & promotions.

### SUMMARY

According to one embodiment herein, a method determines influence between participants in an interaction channel, where the method includes inputting an interaction text response of communication by a participant made in an interaction channel. A type of influence relation of the interaction text response is determined based on relational descriptors. An influence score value is determined for the interaction text response, and a pair-wise indication of a direction of influence is determined of at least two participants in the interaction channel. Interpersonal relationship influence information for the interaction text response is output for a participant pair in the interaction channel.

According to another embodiment herein, a computer-implemented method that determines influence between participants in an interaction channel, the method includes inputting an interaction text response of communication by a participant made in an interaction channel. The interaction text response is annotated based on relational descriptors to output a set of annotation flags corresponding to the interaction text response. The interaction text response is classified based on the relation descriptors to output at least one class label corresponding to the interaction text response. A type of influence relation of the interaction text response is determined based on the set of annotation flags and the at least one class label. An influence score value for the interaction text response is determined based on the annotating and the classifying, where the influence score value represents an extent of influence caused by the interaction text response on one or more participants in the interaction channel. A pair-wise indication of a direction of influence of at least two participants in the interaction channel is determined. Outputting interpersonal relationship influence information representing the type of influence relation between the participant pair, the influence score value between the participant pair, and the pair-wise indication of the direction of influence between the participant pair.

According to another embodiment herein, a computer-implemented method that determines influence between participants in an interaction channel, the method includes inputting an interaction text response of communication by a participant made in an interaction channel. A type of influence relation of the interaction text response is determined on at least one other participant in the interaction channel based on relational descriptors. An influence score value for the interaction text response is determined, where the influence score value indicates how strongly the interaction text response influences the at least one other participant in the interaction channel. A pair-wise indication of a direction of influence of at least two participants in the interaction channel is determined. Interpersonal relationship influence information is output for the interaction text response for a participant pair in the interaction channel.

According to another embodiment herein, a non-transitory computer storage medium readable by a computer tangibly embodying a program of instructions executable by the computer for performing a method for outputting interpersonal relationship influence information between a pair of participants in an interaction channel, inputting an interaction text response of communication by a participant made in an interaction channel. The interaction text response is annotated based on relational descriptors to output a set of annotation flags corresponding to the interaction text response. The interaction text response is classified based on the relation descriptors to output at least one class label corresponding to the interaction text response. A type of influence relation of the interaction text response is determined based on the set of annotation flags and the at least one class label. An influence score value for the interaction text response is determined based on the annotating and the classifying, where the influence score value represents an extent of influence caused by the interaction text response on one or more participants in the interaction channel. A pair-wise indication of a direction of influence of at least two participants in the interaction channel is determined. Outputting interpersonal relationship influence information representing the type of influence relation between the participant pair, the influence score value between the participant pair, and the pair-wise indication of the direction of influence between the participant pair.

### BRIEF DESCRIPTION OF THE SEVERAL VIEWS OF THE DRAWINGS

The embodiments herein will be better understood from the following detailed description with reference to the drawings, which are not necessarily drawing to scale and in which:

FIG. 1 illustrates a first characteristic representation of an interactive communication channel;

FIG. 2 illustrates a schematic diagram of the first characteristic representation of an interactive communication channel;

FIG. 3 illustrates a second characteristic representation of an interactive communication channel;

FIG. 4 illustrates a schematic diagram of the second characteristic representation of an interactive communication channel;

FIG. 5 illustrates a schematic diagram of one embodiment;

FIG. 6 illustrates a schematic diagram of the text relation analyzer of FIG. 5;

FIG. 7 illustrates a schematic diagram of the interpersonal influence database of FIGS. 5-6;

FIG. 8 illustrates a logic flowchart of another embodiment;

FIG. 9 illustrates a logic flowchart of yet another embodiment; and

FIG. 10 is a schematic diagram of a hardware system according to embodiments herein;

FIG. 11 is a schematic diagram of a deployment system according to embodiments herein;

FIG. 12 is a schematic diagram of an integration system according to embodiments herein;

FIG. 13 is a schematic diagram of an on demand system according to embodiments herein; and

FIG. 14 is a schematic diagram of a virtual private network system according to embodiments herein.

### DETAILED DESCRIPTION

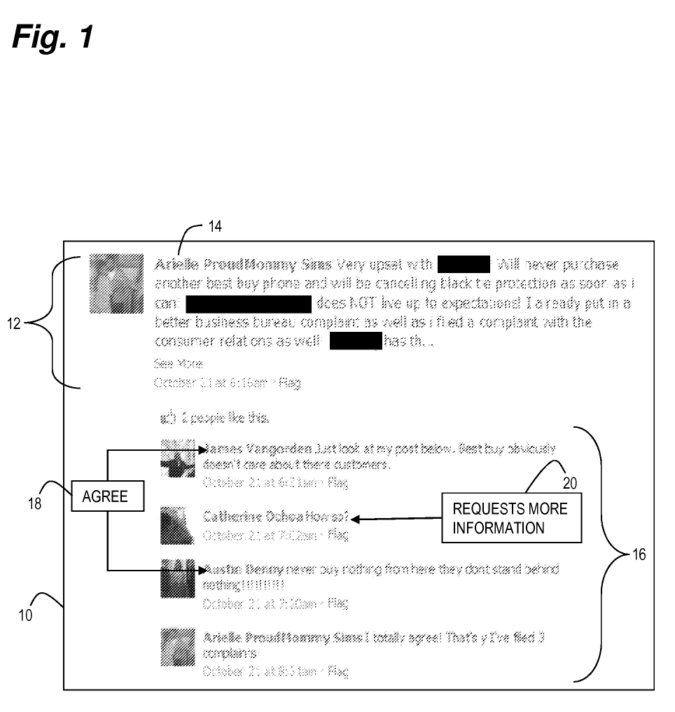

FIG. 1 illustrates a social media interaction forum 10 where an initial post 12 of a member of the forum 14 (“Arielle”) has generated a number of responses 16 by other members of the forum, including the member 14 who posted the initial post 12.

Each response indicates a different kind of influence relation. For example, two members, James and Austin express responses that agree 18 with the initial post 12. Catherine requests more information 20 from the initial poster 14. The contents of each response indicate either if a member is being influenced (if so, by which member), or is influencing another particular member, (if so, to which particular member).

The extent of influence can also be inferred, e.g., someone agreeing to the initial post 12 is being influenced by reinforcing their belief. However, someone newly reacting or asking for more details to the initial post may be developing a new opinion. Someone providing additional information, a solution or disagreeing is in-turn influencing others to different extents.

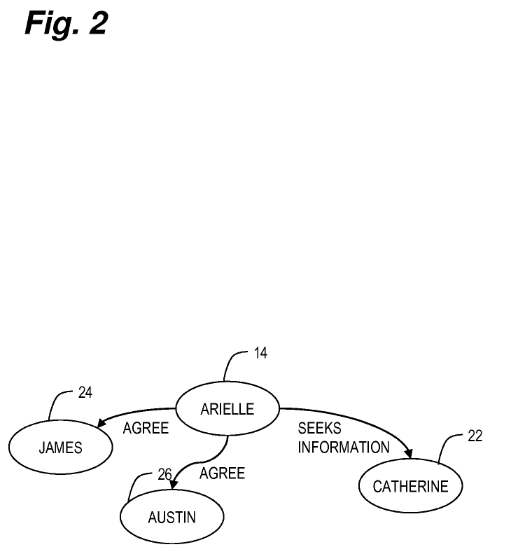

FIG. 2 illustrates a representative schematic diagram of the first three members to respond to the initial post 12 of the social media interaction forum 10 of FIG. 1. Arielle 14 is mentioning a potentially widely experienced issue in the initial post 12. Addressing this issue may have a positive impact on a broader consumer base. Additionally, addressing this issue would help turn Catherine 22, who is at the brink of forming an opinion, (based on her request to have more information 20), into a loyal customer. Again, James, 24 and Austin, 26 agree with the contents of the initial posting 12 of Arielle 14.

A company that addresses the content of the initial posting 12 would form a business rule optimization/execution. Business rule optimization is facilitated by revealing a type (nature), a score (extent) and a direction of influences, from which a business can choose specific relations of interest, (based on the type or the number of people influenced), and design useful business rules. In this context, the business will benefit from the knowledge that many customers face the same problem that Arielle mentioned and can prioritize its resolution. Also Catherine who is seeking information regarding the same can be allotted adequate resources to improve customer satisfaction.

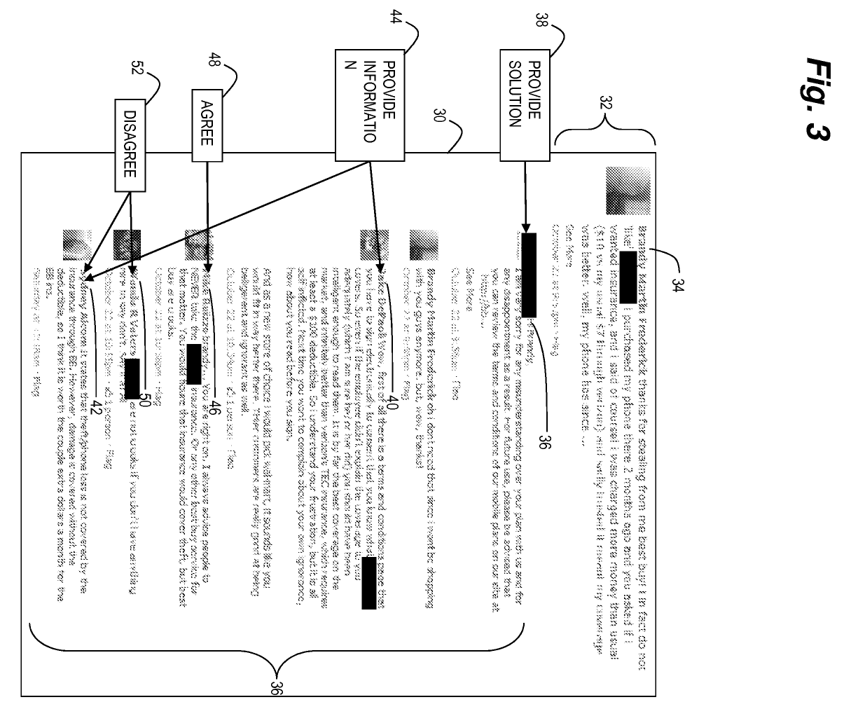

FIG. 3 illustrates another representative social media interaction forum 30 where an initial post 32 of a member of the forum 34 (“Brandy”) has generated a number of responses 36 by other members of the forum, including the member 14 who posted the initial post 12. Here, Best 36 offers to provide a solution 38, and Jake 40 and Sydney 42 offer to provide more information 44. Mike 46 agrees 48 with the initial post 32, but Wanda 50 and Sydney 42 disagree 52.

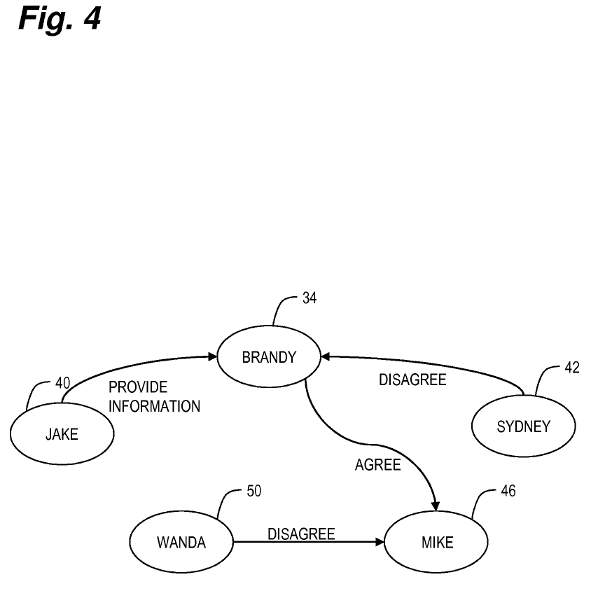

FIG. 4 illustrates a representative schematic diagram of the first six responses to the initial post 32 of the social media interaction forum 30 of FIG. 3. Brandy 34 is mentioning a potentially widely experienced issue in the initial post 32. Jake 40 provides information to Brandy 34, while Sydney 42 disagrees with Brandy 34, and Mike 46 agrees with Brandy 34. However, Wanda disagrees with Mike 46.

Jake 40, Sydney 42 and Wanda 50 can be considered loyal, and in disagreement with Brandy's initial posting 32. If Brandy 34 decides to churn, the only person likely to be impacted is Mike 46.

Churn prediction applications can benefit from the embodiments presented herein by knowing the nature, extent and direction of influence relations and choose a relation of a certain nature, an extent and a number of people influenced, (by tracing the influence direction), for better prediction of churners. In this context, it may be inferred that “AGREE” based relations, if Brandy churns out, Mike is most likely to churn as well, as Mike shares a similar opinion with Brandy.

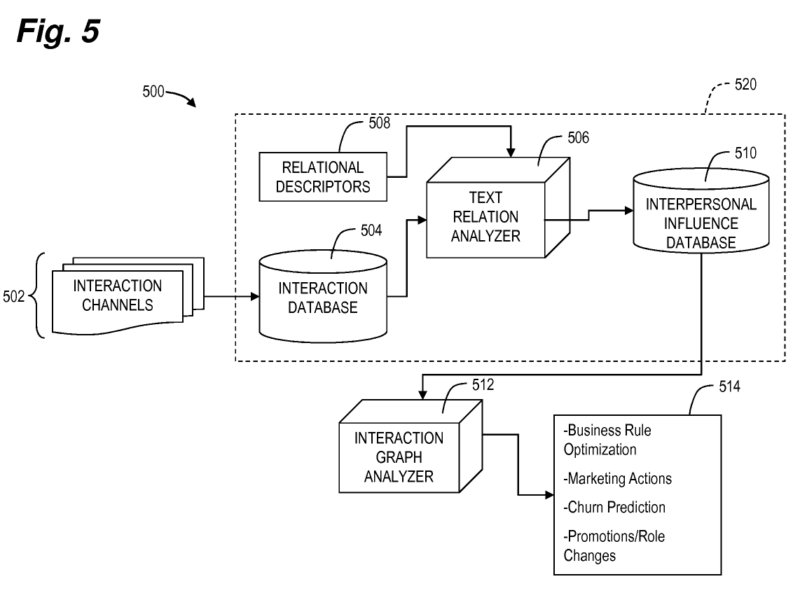

FIG. 5 illustrates a schematic diagram of one representative embodiment that shows a system 500 for determining a nature, an extent and a direction of influence from interpersonal interactions of participants within any number of social media interaction channels 502 that input each interaction “thread” or text response from each user for storage into an interaction database 504. The interaction database 504 then inputs each interaction text response, (or forum thread), to a text relation analyzer 506 where each interaction text response captured is subjected to annotation and classification to determine a nature of influence the interaction text response depicts. Different kinds of influence relations may be defined to determine the nature of influence by relation descriptors 508 input into the text relation analyzer 506 using text based annotation rules and classification models. The output of annotation and classification is used to score the response for an extent of influence of the interaction text response. An influence direction analysis component within the text relation analyzer determines the source the receiver of the influence relation.

The text relation analyzer outputs data regarding interpersonal influence relations that may be stored in an interpersonal influence database 510 and used by any existing multi-valued, multi-topic, directed graph analysis system 514 to perform predictive analysis for different business problems 514 like business rule optimization (e.g., customer retention), marketing actions (e.g., viral marketing), churn prediction, and promotions or role changes.

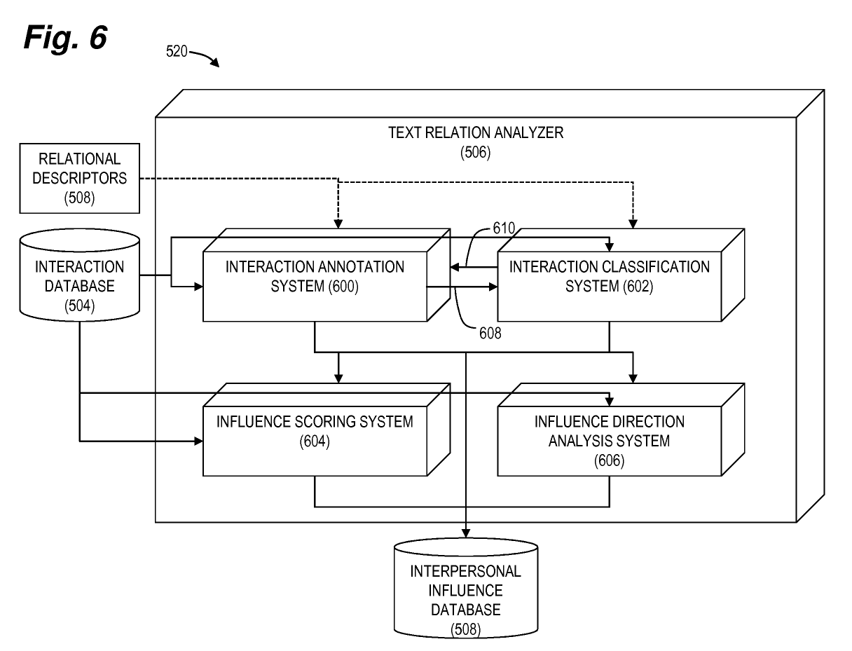

FIG. 6 illustrates in further details the function of the text relation analyzer 506 of FIG. 5 and its surrounding connected components 520.

The relationship descriptors 508 component can be considered a repository of resources, i.e., the keywords, regular expression rules, and classification models. These resources can be changed and/or updated as per any particular application requirement; they impact on what kind of relations that are determined from the interaction text responses processed by the system 500. In other words, relational descriptors 508 operate as a resource bank of descriptors needed for the annotation and classification functionality described below.

The text relation analyzer 506 comprises an interaction annotation system 600 that uses keywords and regular expression rules from the relational descriptor 508 repository to annotate incoming interaction text responses. Annotation is a general term used for an information extraction technique that identifies useful or relevant entities such as names, products, sentiments, or questions present in an input interaction text response from the interaction database 504. The process of annotation works with keywords, regular expression rules and combinations of the keywords and regular expression rules. E.g., [“Wh”−question+product name+“price”] might be a simple rule to detect questions regarding pricing of a certain product. The annotation rules can be configured to match application requirement. This can be done either manually or by automated techniques or a combination of both manual and automatic. The output of interactive annotation system 600 may be a set of annotation flags of which particular annotation rules where activated by a given portion of an input interaction text response. Additionally, the interactive annotation system 600 may also in addition output the positions, (in the interaction text response), where each particular rule was activated.

Annotation output may be a set of flags identifying which annotation rules were applied to a given piece of text, and additionally annotation output may also output the positions in the text where these rules were applied. A function of these outputs can be used to compute a score value, (e.g. “annotation_score”=k*no. of rules matched−q*(AVG(Distance (positions)))), where k and q are weight parameters for scaling contributions of the metrics. “AVG (Distance(positions))” corresponds to the average of distances in positions in the text at which different rules that where matched were satisfied.

The classification system may output at least one class label for an input interaction text piece, additionally it might also output the class probabilities. The probability values can be used as a score value, alternately a function with predicted category, (and/or its probability), as parameters can be used to compute the score, say “classification_score.” Finally the “annotation_score” and “classification_score” may be combined, (e.g. weighted sum), to compute an influence score.

The text relation analyzer 506 additionally comprises an interaction classification system 602 that uses classification models from the relational descriptors 508 repository to assign class labels to each interaction text response using certain features, e.g., words, part-of-speech, context, and the annotation flags from the interaction annotation system 600 to determine the nature of an input interaction text response from the interaction database 504. Depending on the kind of classification models, the interaction text response itself can be classified with class labels into different kinds of interaction classes, e.g., whether an interaction text response is a complaint, an enquiry, a suggestion or praise. The classification models can be built as per application requirement through a training phase or by reusing already trained models. The interaction classification system 602 outputs at least one class label for each input interaction text response, and additionally the system 602 may also output class probabilities, i.e., a certainty value related to each class label, for each input interaction text response.

In one embodiment, the output set of annotation flags from the interaction annotation system 600 may be used as features for the interaction classification system 602 as illustrated by the arrow at reference number 608.

In other embodiment, based on the at least one class label output by the interaction classification system 602, only certain annotation rules might be executed by the interaction annotation system 600, as illustrated by the arrow at reference number 610.

In yet another embodiment, the output of the interaction annotation system 600 may be used to preprocess the input interaction text response from the interaction database 504 (see 608) to impact at least one class label output by the interaction classification system 602 based on solution design of implementation.

The combined set of output annotation flags from the interaction annotation system 600 and at least one class label from the interaction classification system 602 are used to represent the nature of each input interaction text response.

The text relation analyzer 506 additionally comprises an influence scoring system 604 that determines an extent of influence caused by each input interaction text response on the participants of the interaction. Outputs from the annotation flags from the interaction annotation system 600 and at least one class label from the interaction classification system 602, and combinations of them, are used to compute an influence score that indicates how strongly each interaction text response influenced participants, i.e., an extent of influence. This score can be computed either independently for each interaction text response, or individually for pairs of participants where annotations and classifications of the interaction text responses from the other participants are also considered, (e.g., where an identification of a similarity in sentiments may be present among a plurality of participants).

The text relation analyzer 506 additionally comprises an influence direction analysis system 606 that determines the direction of the influence cause by interaction text response on participants in the interactive social media forum of the interaction channels 502. For example, typically the direction of influence is from some member providing information to some other member who has asked for it. (See FIGS. 2 and 4.) To determine the direction of the influence, references to entities in the interaction text response can be used from the output of the interaction annotation system 600, (i.e., the set of annotation flags), and the interaction classification system 602 (i.e., the at least one class label), with anaphora resolution (or entity reference resolution) techniques. (In linguistics, anaphora is an instance of an expression referring to another expression.) This may be done by analyzing the named references, noun-pronoun linking, position of response in interactive text response etc.

Additionally information of a response sequence can also be used to help the process of influence direction detection. The output of this component is a pair-wise indication of direction of influence, if present, for the participants. For example, if member A and member B are participating in an interaction, for a response by B, the output of this component indicates: 1) the existence of an influence relation, and 2) the direction of influence between A and B.

The influence score and type for the attributes define an edge between two participants of the conversation. The direction will dictate the direction of the edge. In this manner a complete network of people will be generated from conversation threads. Next, the generated network of people may be used by any third party network analysis tool to perform studies like churn prediction, business rules, etc.

The interpersonal influence database 510 is a database of interpersonal influence relations of members containing interpersonal relationship influence information on: 1) the nature of relationship output from the interaction classification system 602; 2) the extent of relationship output from the influence scoring system 604; and 3) the direction of relationship output from the influence direction analysis system 606.

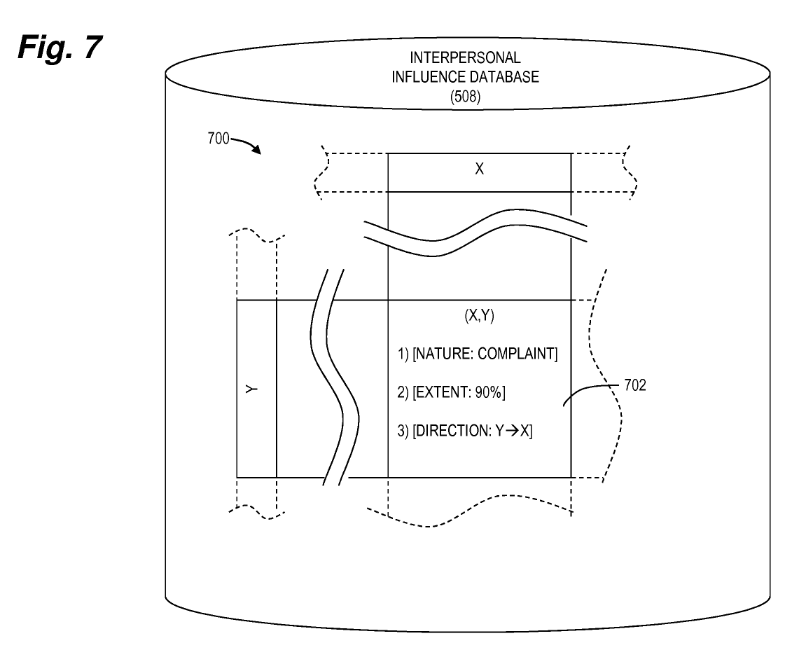

For example, FIG. 7 illustrates an interaction relationship matrix 700 of people having a cell [X,Y], 702, (representing parameters that define the relationship parameters between member X and member Y), in the matrix. This cell 702 may, for example, contain entries of a nature, “complaint,” an extent of influence, “90%,” and direction of influence relationship between X and Y, “Y→X”. There may be multiple entries in a cell giving details of member relations of a different nature.

Referring back to FIG. 5, the interaction graph analyzer 512 takes the output from the interpersonal influence database 510 and determines business rule optimizations, marketing actions, churn prediction and/or promotions/role changes 514. The interaction graph analyzer 512 may be any third party social network analysis tool capable of handling a multi-valued, multi-topic, directed network, and may be considered a consumer of the output generated by the text relation analyzer 506.

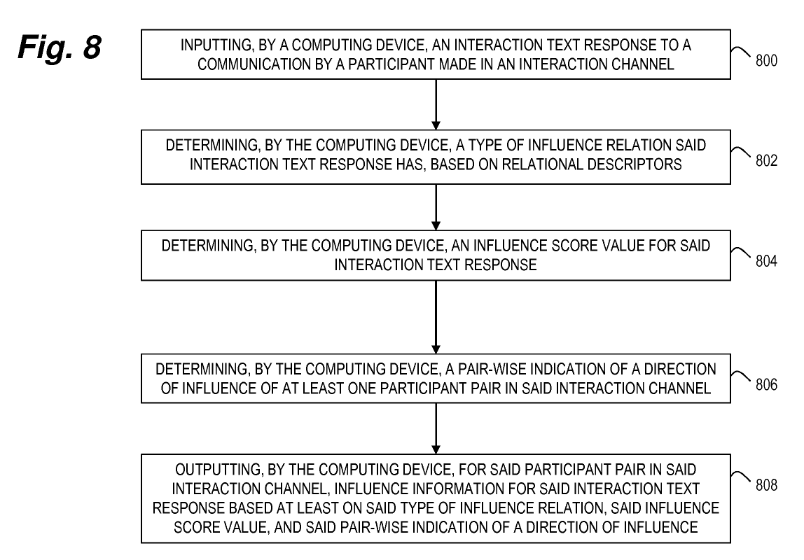

FIG. 8 illustrates a computer-implemented method that determines influence between participants in an interaction channel, the method includes inputting an interaction text response of communication by a participant made in an interaction channel 800. A type of influence relation of the interaction text response is determined on at least one other participant in the interaction channel based on relational descriptors 802. An influence score value for the interaction text response is determined in 804. The influence score value indicates how strongly the interaction text response influences the at least one other participant in the interaction channel. A pair-wise indication of a direction of influence of at least two participants in the interaction channel is determined 806. Interpersonal relationship influence information is output for the interaction text response for a participant pair in the interaction channel 808.

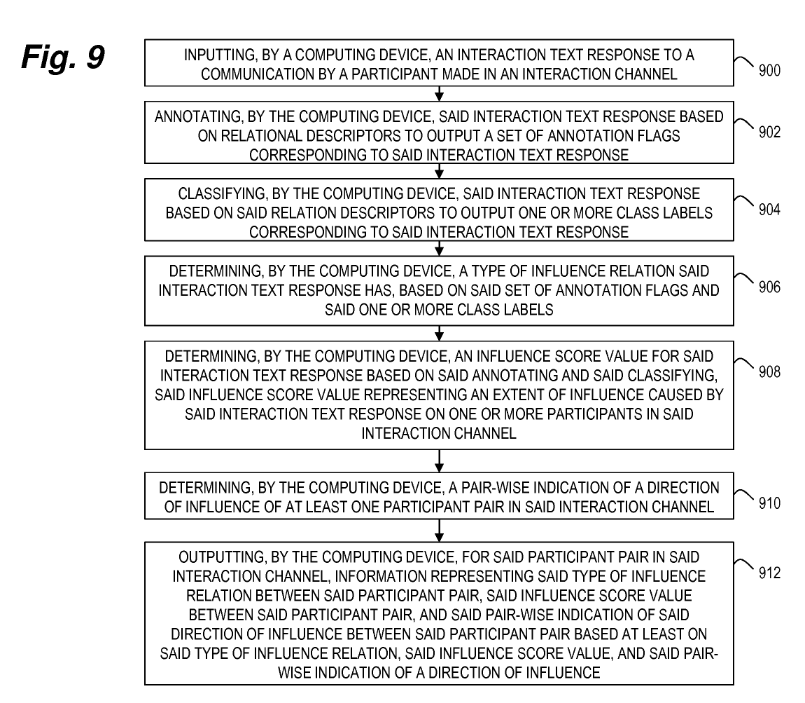

FIG. 9 illustrates a computer-implemented method that determines influence between participants in an interaction channel, the method includes inputting an interaction text response of communication by a participant made in an interaction channel 900. The interaction text response is annotated based on relational descriptors to output a set of annotation flags corresponding to the interaction text response 902. The interaction text response is classified based on the relation descriptors to output at least one class label corresponding to the interaction text response 904. A type of influence relation of the interaction text response is determined based on the set of annotation flags and the at least one class label 906. An influence score value for the interaction text response is determined based on the annotating and the classifying, where the influence score value represents an extent of influence caused by the interaction text response on one or more participants in the interaction channel 908. A pair-wise indication of a direction of influence of at least two participants in the interaction channel is determined 910. Outputting interpersonal relationship influence information representing the type of influence relation between the participant pair, the influence score value between the participant pair, and the pair-wise indication of the direction of influence between the participant pair 912.

The relation descriptors further comprise keywords, regular expression rules and classification models. Determining the type of influence relation further includes annotating, by the computing device, the interaction text response based on the keywords and regular expression rules to output a set of annotation flags corresponding to the interaction text response. Determining the type of influence relation further includes classifying, by the computing device, the interaction text response based on the classification models to output at least one class label corresponding to the interaction text response.

The influence score value represents an extent of influence caused by the interaction text response on one or more participants in the interaction channel. The interpersonal relationship influence information includes: the type of influence relation between the participant pair; the influence score value between the participant pair; and the pair-wise indication of the direction of influence between the participant pair.

The interaction channel may include one of an e-mail, a social media channel, an online bulletin board system, an online chat room, and an online forum.

The relational descriptors may be updated based on a particular application requirement.

The type of influence relation may further include interpersonal relationship influence information regarding a position in the interaction text response where a particular regular expression rule has been activated. The type of influence relation further includes class labels that have a class probability value representing a certainty for a class label corresponding to the input interaction text response. The type of influence relation further comprises a set of annotation flags used as features for classification in an interaction classification system. The type of influence relation further comprises at least one class label that cause certain annotation rules to be executed by an interaction annotation system.

The type of influence relation further causes preprocessing of the input interaction text response based upon a set of annotation flags to cause at least one class label to be output by an interaction classification system.

The influence score value may include one of an independent score value for each interaction text response, and a participant pair score value for a pair of participants based on the interaction text response.

The type of influence relation, influence score value and direction of influence are the attributes that interpersonal relations are comprised of: a relation has a nature (type) of influence; the nature of influence of the relation has an extent (score) of influence. Also, each relation of influence has a direction depicting the flow or direction of influence.

For example, a second participant responds to something that a first participant said with some advice or suggestion. The second participant may influence the first participate through a type of influence classified as “advice,” which impacts the first participant to a particular extent, i.e., a quantifiable score of “0.7” (indicative of how important is the second participant's opinion is to the first participant), and finally since it is the second participant who is influencing the first participant, the direction of influence is from the second to the first participant. So the type, (advice), score, (0.7), and direction (second to first participant), is used to describe a relation as interpersonal relationship influence information. It is also possible for a pair of participants to share multiple relations of different types and directions each associated with a score.

As will be appreciated by one skilled in the art, aspects of the embodiments herein may be embodied as a system, method or computer program product. Accordingly, aspects of the embodiments herein may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the embodiments herein may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the embodiments herein may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the embodiments herein are described below with reference to flowchart illustrations and/or block diagrams of methods, apparatus (systems) and computer program products according to the embodiments herein. It will be understood that each block of the flowchart illustrations and/or D-2 block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

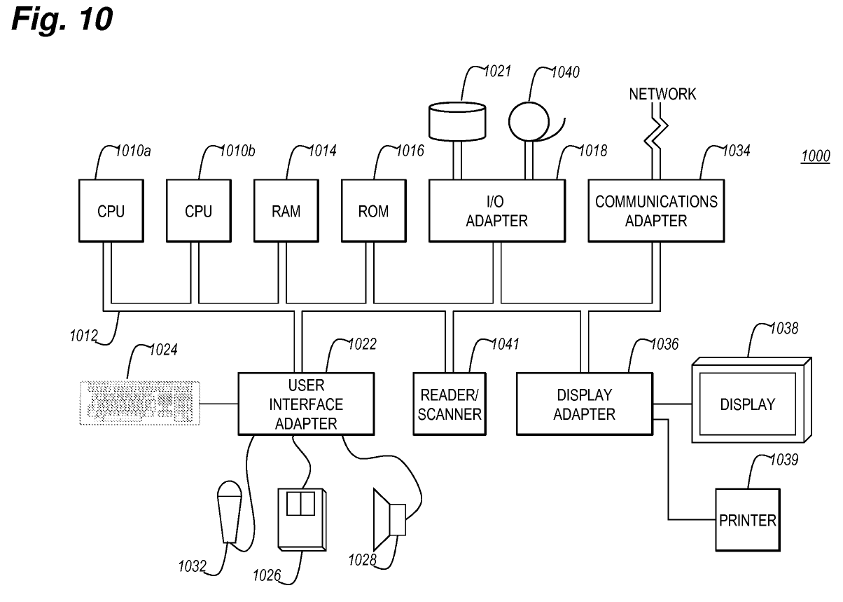

A representative hardware environment for practicing the embodiments herein is depicted in FIG. 10. This schematic drawing illustrates a hardware configuration of an information handling/computer system in accordance with the embodiments herein. The system comprises at least one processor or central processing unit (CPU) 1010a/b. The CPUs 1010a/b are interconnected via system bus 1012 to various devices such as a random access memory (RAM) 1014, read-only memory (ROM) 1016, and an input/output (I/O) adapter 1018. The I/O adapter 1018 can connect to peripheral devices, such as disk units 1021 and tape drives 1040, or other program storage devices that are readable by the system. The system can read the inventive instructions on the program storage devices and follow these instructions to execute the methodology of the embodiments herein. The system further includes a user interface adapter 1022 that connects a keyboard 1024, mouse 1026, speaker 1028, microphone 1032, and/or other user interface devices such as a touch screen device (not shown) to the bus 1012 to gather user input. Additionally, a communication adapter 1034 connects the bus 1012 to a data processing network, and a display adapter 1036 connects the bus 1012 to a display device 1038 which may be embodied as an output device such as a monitor 1038, printer 1039, or transmitter (not shown), for example.

The flowchart and block diagrams in the FIG. 10 illustrate the architecture, functionality, and operation of possible implementations of systems, methods and computer program products according to various embodiments herein. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Deployment Types include loading directly in the client, server and proxy computers via loading a storage medium such as a CD, DVD, etc. The process software may also be automatically or semi-automatically deployed into a computer system by sending the process software to a central server or a group of central servers. The process software is then downloaded into the client computers that will execute the process software. The process software is sent directly to the client system via e-mail. The process software is then either detached to a directory or loaded into a directory by a button on the e-mail that executes a program that detaches the process software into a directory. Send the process software directly to a directory on the client computer hard drive. When there are proxy servers, the process will, select the proxy server code, determine on which computers to place the proxy servers' code, transmit the proxy server code, then install the proxy server code on the proxy computer. The process software will be transmitted to the proxy server then stored on the proxy server.

While it is understood that the process software may be deployed by manually loading directly in the client, server and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively the process software is sent directly to the client system via e-mail. The process software is then either detached to a directory or loaded into a directory by a button on the e-mail that executes a program that detaches the process software into a directory. Another alternative is to send the process software directly to a directory on the client computer hard drive. When there are proxy servers, the process will, select the proxy server code, determine on which computers to place the proxy servers' code, transmit the proxy server code, then install the proxy server code on the proxy computer. The process software will be transmitted to the proxy server then stored on the proxy server.

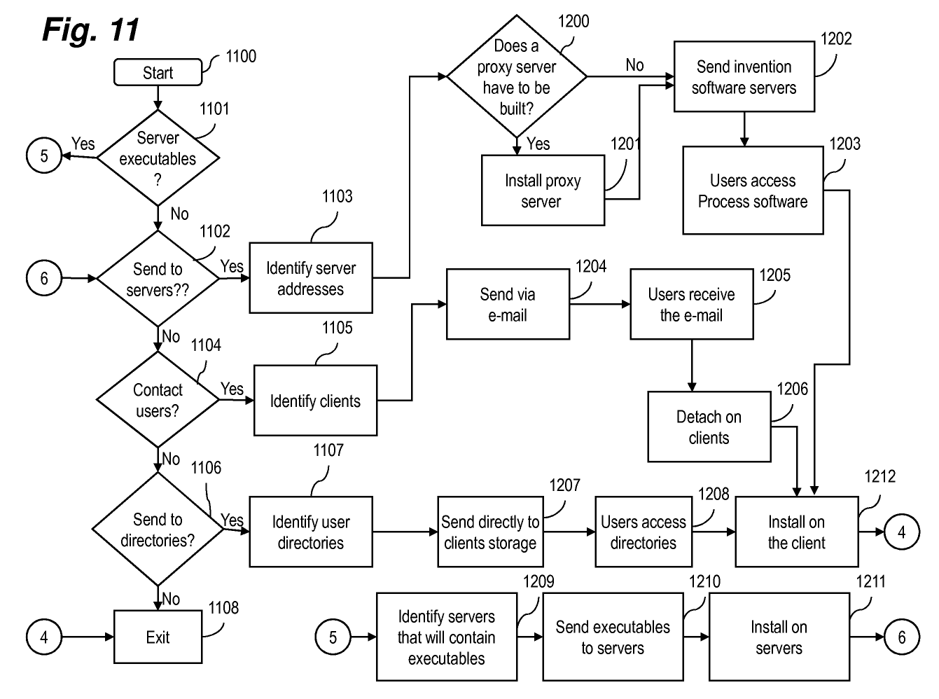

In FIG. 11 step 1100 begins the deployment of the process software. The first thing is to determine if there are any programs that will reside on a server or servers when the process software is executed 1101. If this is the case then the servers that will contain the executables are identified 1209. The process software for the server or servers is transferred directly to the servers' storage via FTP or some other protocol or by copying though the use of a shared file system 1210. The process software is then installed on the servers 1211.

Next, a determination is made on whether the process software is be deployed by having users access the process software on a server or servers 1102. If the users are to access the process software on servers then the server addresses that will store the process software are identified 1103.

A determination is made if a proxy server is to be built 1200 to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required then the proxy server is installed 1201. The process software is sent to the servers either via a protocol such as FTP or it is copied directly from the source files to the server files via file sharing 1202. Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems 1203. Another embodiment is to have the servers automatically copy the process software to each client and then run the installation program for the process software at each client computer. The user executes the program that installs the process software on his client computer 1212 then exits the process 1108.

In step 1104 a determination is made whether the process software is to be deployed by sending the process software to users via e-mail. The set of users where the process software will be deployed are identified together with the addresses of the user client computers 1105. The process software is sent via e-mail to each of the users' client computers. The users then receive the e-mail 1205 and then detach the process software from the e-mail to a directory on their client computers 1206. The user executes the program that installs the process software on his client computer 1212 then exits the process 1108.

Lastly a determination is made on whether to the process software will be sent directly to user directories on their client computers 1106. If so, the user directories are identified 1107. The process software is transferred directly to the user's client computer directory 1207. This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software 1208. The user executes the program that installs the process software on his client computer 1212 then exits the process 1108.

The process software which consists of is integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

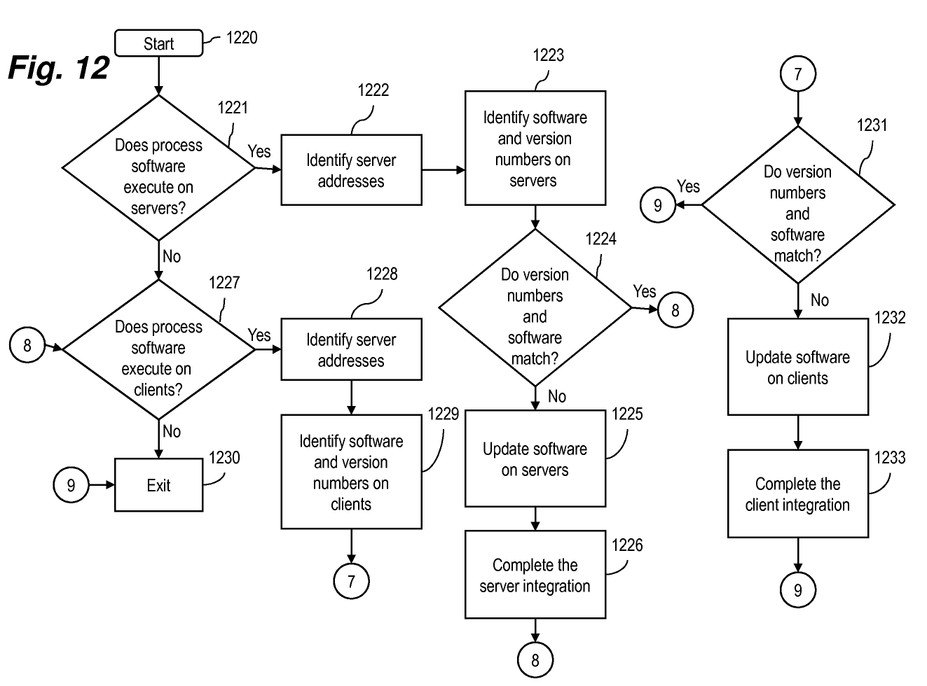

In FIG. 12 step 1220 begins the integration of the process software. The first thing is to determine if there are any process software programs that will execute on a server or servers 1221. If this is not the case, then integration proceeds to 1227. If this is the case, then the server addresses are identified 1222. The servers are checked to see if they contain software that includes the operating system (OS), applications, and network operating systems (NOS), together with their version numbers, which have been tested with the process software 1223. The servers are also checked to determine if there is any missing software that is required by the process software 1223.

A determination is made if the version numbers match the version numbers of OS, applications and NOS that have been tested with the process software 1224. If all of the versions match and there is no missing required software the integration continues in 1227.

If one or more of the version numbers do not match, then the unmatched versions are updated on the server or servers with the correct versions 1225. Additionally if there is missing required software, then it is updated on the server or servers 1225. The server integration is completed by installing the process software 1226.

Step 1227 which follows either 1221, 1224 or 1226 determines if there are any programs of the process software that will execute on the clients. If no process software programs execute on the clients the integration proceeds to 1230 and exits. If this not the case, then the client addresses are identified 1228.

The clients are checked to see if they contain software that includes the operating system (OS), applications, and network operating systems (NOS), together with their version numbers, which have been tested with the process software 1229. The clients are also checked to determine if there is any missing software that is required by the process software 1229.

A determination is made as to whether the version numbers match the version numbers of OS, applications and NOS that have been tested with the process software 1231. If all of the versions match and there is no missing required software, then the integration proceeds to 1230 and exits.

If one or more of the version numbers do not match, then the unmatched versions are updated on the clients with the correct versions 1232. In addition, if there is missing required software then it is updated on the clients 1232. The client integration is completed by installing the process software on the clients 1233. The integration proceeds to 1230 and exits.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc. When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload. The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider. In another embodiment, the service provider requests payment directly from a customer account at a banking or financial institution. In another embodiment, if the service provider is also a customer of the customer that uses the process software application, the payment owed to the service provider is reconciled to the payment owed by the service provider to minimize the transfer of payments.

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

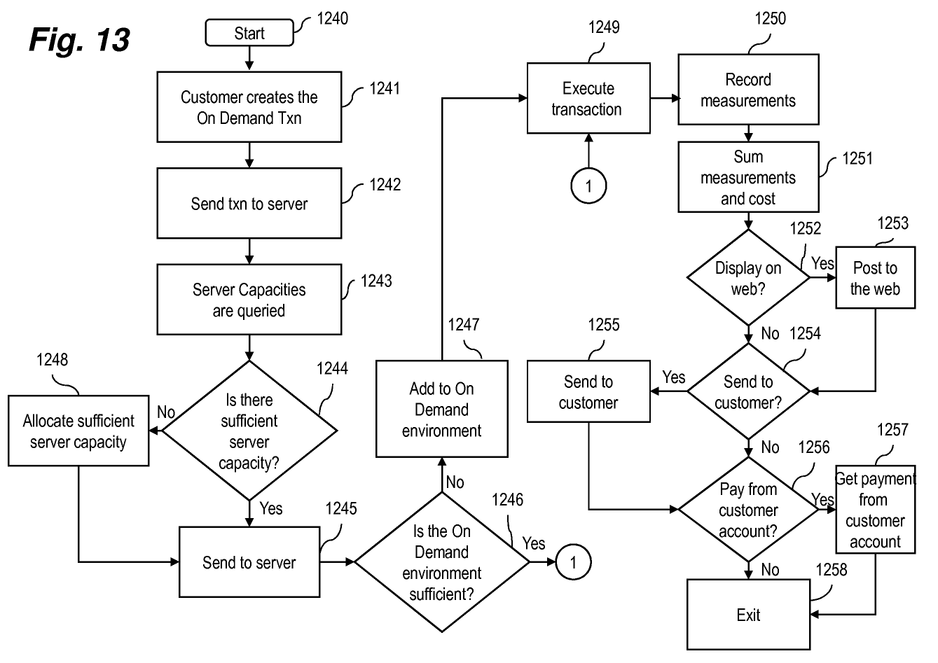

In FIG. 13 step 1240 begins the On Demand process. A transaction is created than contains the unique customer identification, the requested service type and any service parameters that further specify the type of service 1241. The transaction is then sent to the main server 1242. In an On Demand environment the main server can initially be the only server, then as capacity is consumed other servers are added to the On Demand environment.

The server central processing unit (CPU) capacities in the On Demand environment are queried 1243. The CPU requirement of the transaction is estimated, then the servers available CPU capacity in the On Demand environment are compared to the transaction CPU requirement to see if there is sufficient CPU available capacity in any server to process the transaction 1244. If there is not sufficient server CPU available capacity, then additional server CPU capacity is allocated to process the transaction 1248. If there was already sufficient Available CPU capacity then the transaction is sent to a selected server 1245.

Before executing the transaction, a check is made of the remaining On Demand environment to determine if the environment has sufficient available capacity for processing the transaction. This environment capacity consists of such things as but not limited to network bandwidth, processor memory, storage etc. 1246. If there is not sufficient available capacity, then capacity will be added to the On Demand environment 1247. Next the required software to process the transaction is accessed, loaded into memory, then the transaction is executed 1249.

The usage measurements are recorded 1250. The usage measurements consists of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer 1251. If the customer has requested that the On Demand costs be posted to a web site 1252 then they are posted 1253.

If the customer has requested that the On Demand costs be sent via e-mail to a customer address 1254 then they are sent 1255. If the customer has requested that the On Demand costs be paid directly from a customer account 1256 then payment is received directly from the customer account 1257. The last step is exit the On Demand process.

The process software may be deployed, accessed and executed through the use of a virtual private network (VPN), which is any combination of technologies that can be used to secure a connection through an otherwise unsecured or untrusted network. The use of VPNs is to improve security and for reduced operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process the of placing an entire packet within another packet and sending it over a network. The protocol of the outer packet is understood by the network and both points, called tunnel interfaces, where the packet enters and exits the network.

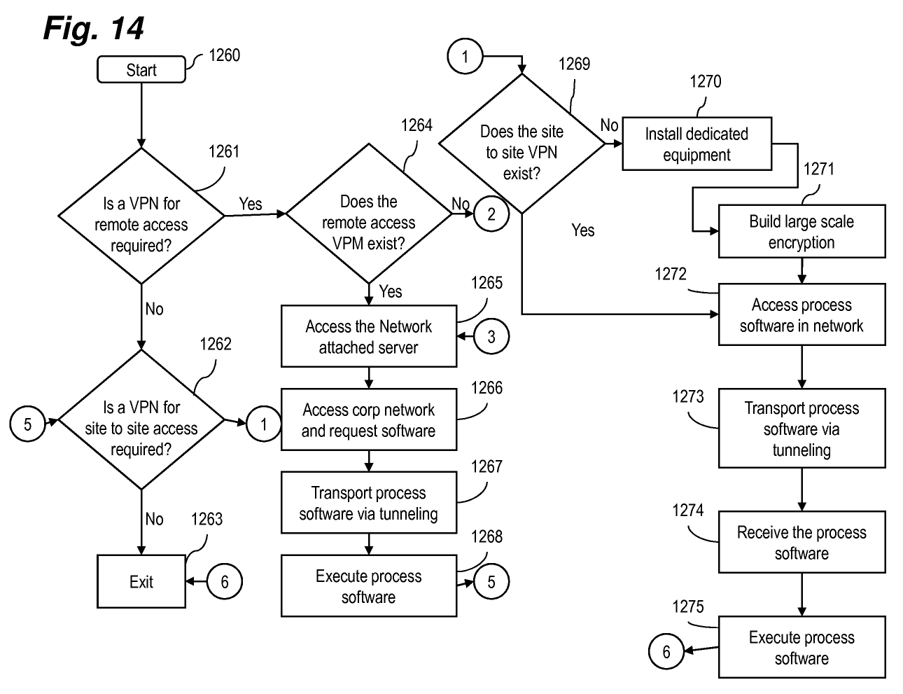

In FIG. 14 step 1260 begins the Virtual Private Network (VPN) process. A determination is made to see if a VPN for remote access is required 1261. If it is not required, then proceed to 1262. If it is required, then determine if the remote access VPN exists 1264. If it does exist, then proceed to 1265. After the remote access VPN has been built or if it been previously installed, the remote users can then access the process software by dialing into the NAS or attaching directly via a cable or DSL modem into the NAS 1265. This allows entry into the corporate network where the process software is accessed 1266. The process software is transported to the remote user's desktop over the network via tunneling. That is the process software is divided into packets and each packet including the data and protocol is placed within another packet 1267. When the process software arrives at the remote user's desktop, it is removed from the packets, reconstituted and then is executed on the remote users desktop 1268.

A determination is made to see if a VPN for site to site access is required 1262. If it is not required, then proceed to exit the process 1263. Otherwise, determine if the site to site VPN exists 1269. If it does exist, then proceed to 1272. Otherwise, install the dedicated equipment required to establish a site to site VPN 1270. Then, build the large scale encryption into the VPN 1271.

After the site to site VPN has been built or if it had been previously established, the users access the process software via the VPN 1272. The process software is transported to the site users over the network via tunneling 1273. That is the process software is divided into packets and each packet including the data and protocol is placed within another packet 1274. When the process software arrives at the remote user's desktop, it is removed from the packets, reconstituted and is executed on the site users desktop 1275. Proceed to exit the process 1263.

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments herein have been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the embodiments for various embodiments with various modifications as are suited to the particular use contemplated.

1-20. (canceled)

21. A non-transitory computer storage medium readable by a computer tangibly embodying a program of instructions executable by said computer for performing a method for outputting interpersonal relationship influence information between a pair of participants in an interaction channel, said method comprising:
inputting an interaction text response to a communication by a participant made in said interaction channel;
annotating said interaction text response based on relational descriptors to output a set of annotation flags corresponding to said interaction text response;
classifying said interaction text response based on said relation descriptors to output class labels corresponding to said interaction text response;
determining a type of influence relation said interaction text response has, based on said set of annotation flags and said class labels;
determining an influence score value for said interaction text response based on said annotating and said classifying, said influence score value representing an extent of influence caused by said interaction text response on one or more participants in said interaction channel;
determining a pair-wise indication of a direction of influence of at least one participant pair in said interaction channel; and
outputting for said participant pair in said interaction channel, interpersonal relationship influence information representing said type of influence relation between said participant pair, said influence score value between said participant pair, and said pair-wise indication of said direction of influence between said participant pair based at least on said type of influence relation, said influence score value, and said pair-wise indication of a direction of influence.

22. The non-transitory computer storage medium according to claim 21, said relation descriptors further comprising keywords, regular expression rules and classification models.

23. The non-transitory computer storage medium according to claim 22, said annotating outputs said set of annotation flags based on said keywords and regular expression rules.

24. The non-transitory computer storage medium according to claim 22, said classifying outputs said class labels based on said classification models.

25. The non-transitory computer storage medium according to claim 21, said interaction channel comprising one of:
e-mail;
a social media channel;
an online bulletin board system;
an online chat room; and
an online forum.

26. A non-transitory computer storage medium readable by a computer tangibly embodying a program of instructions executable by said computer for performing a method for outputting interpersonal relationship influence information between a pair of participants in an interaction channel, said method comprising:
inputting, an interaction text response to a communication by a participant made in an interaction channel;
determining, a type of influence relation said interaction text response has, based on relational descriptors;
determining, an influence score value for said interaction text response;
determining, a pair-wise indication of a direction of influence of at least one participant pair in said interaction channel; and
outputting, for said participant pair in said interaction channel, said interpersonal relationship influence information for said interaction text response comprising said type of influence relation, said influence score value, and said pair-wise indication of a direction of influence.

27. The non-transitory computer storage medium according to claim 26, said relation descriptors further comprising keywords, regular expression rules and classification models.

28. The non-transitory computer storage medium according to claim 27, said determining of said type of influence relation further comprises:
annotating, said interaction text response based on said keywords and regular expression rules to output a set of annotation flags corresponding to said interaction text response.

29. The non-transitory computer storage medium according to claim 27, said determining of said type of influence relation further comprises:
classifying, said interaction text response based on said classification models to output class labels corresponding to said interaction text response.

30. The non-transitory computer storage medium according to claim 26, said influence score value representing an extent of influence caused by said interaction text response on one or more participants in said interaction channel.

31. The non-transitory computer storage medium according to claim 26, said interpersonal relationship influence information comprises:
said type of influence relation between said participant pair;
said influence score value between said participant pair; and
said pair-wise indication of said direction of influence between said participant pair.

32. The non-transitory computer storage medium according to claim 26, said interaction channel comprising at least one of:
e-mail;
a social media channel;
an online bulletin board system;
an online chat room; and
an online forum.

33. A non-transitory computer storage medium readable by a computer tangibly embodying a program of instructions executable by said computer for performing a method for outputting interpersonal relationship influence information between a pair of participants in an interaction channel, said method comprising:
inputting, an interaction text response to a communication by a participant made in an interaction channel;
determining, a type of influence relation of said interaction text response on at least one other participant in said interaction channel based on relational descriptors;
determining, an influence score value for said interaction text response, said influence score value indicates how strongly said interaction text response influences said at least one other participant in said interaction channel;
determining, a pair-wise indication of a direction of influence of at least one participant pair in said interaction channel; and
outputting, for said participant pair in said interaction channel, interpersonal relationship influence information for said interaction text response based at least on said type of influence relation, said influence score value, and said pair-wise indication of a direction of influence.

34. The non-transitory computer storage medium according to claim 33, further comprising:
updating, said relational descriptors based on a particular application requirement.

35. The non-transitory computer storage medium according to claim 33, where said type of influence relation further includes information regarding a position in said interaction text response where a particular regular expression rule has been activated.

36. The non-transitory computer storage medium according to claim 33, where said type of influence relation further includes class labels that have a class probability value representing a certainty for a class label corresponding to said input interaction text response.

37. The non-transitory computer storage medium according to claim 33, where said type of influence relation further comprises a set of annotation flags used as features for classification in an interaction classification system.

38. The non-transitory computer storage medium according to claim 33, where said type of influence relation further comprises class labels that cause certain annotation rules to be executed by an interaction annotation system.

39. The non-transitory computer storage medium according to claim 33, where said type of influence relation further causes preprocessing of said input interaction text response based upon a set of annotation flags to cause class labels to be output by an interaction classification system.

40. The non-transitory computer storage medium according to claim 33, said influence score value comprising one of:
an independent score value for each interaction text response; and
a participant pair score value for a pair of participants based on said interaction text response.
